(19) United States
(12) Patent Application Publication
(10) Pub. No.: US 2025/0380258 A1
(43) Pub. Date: Dec. 11, 2025

(54) UPLINK CONTROL INFORMATION MULTIPLEXING ON PHYSICAL UPLINK SHARED CHANNEL WITH MULTIPLE CODE WORDS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/876,123

(22) PCT Filed: Aug. 15, 2022
(86) PCT No.: PCT/CN2022/112377

§ 371 Date: Dec. 17, 2024

(51) Int. Cl. H04W 72/1273; H04L 1/00; H04W 72/21

(52) U.S. Cl. CPC H04W 72/1273; H04L 1/0003; H04L 1/0009; H04W 72/21

(57) ABSTRACT

Certain aspects of the present disclosure provide a method for wireless communication by a user equipment (UE), generally including receiving signaling enabling at least two code words (CWs) to be scheduled by a downlink control information (DCI), receiving a DCI scheduling a physical uplink shared channel (PUSCH) with less than two uplink (UL) transport blocks (TBs) with data wherein the DCI indicates at least two modulation and coding schemes (MCSs) for the PUSCH, determining time and frequency resources for multiplexing uplink control information (UCI) in the PUSCH; and transmitting the PUSCH with UCI multiplexed in accordance with the determination.

### BACKGROUND

### Field of the Disclosure

Aspects of the present disclosure relate to wireless communications, and more particularly, to techniques for multiplexing uplink control information (UCI) on a physical uplink shared channel (PUSCH).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving signaling enabling at least two code words (CWs) to be scheduled by a downlink control information (DCI); receiving a DCI scheduling a physical uplink shared channel (PUSCH) with less than two uplink (UL) transport blocks (TBs) with data wherein the DCI indicates at least two modulation and coding schemes (MCSs) for the PUSCH; determining time and frequency resources for multiplexing uplink control information (UCI) in the PUSCH; and transmitting the PUSCH with UCI multiplexed in accordance with the determination.

Another aspect provides a method for wireless communication by a network entity. The method includes transmitting signaling enabling at least two CWs to be scheduled by a DCI; transmitting a DCI scheduling a UE for a PUSCH with less than two UL TBs with data wherein the DCI indicates at least two MCSs for the PUSCH; determining time and frequency resources used by the UE for multiplexing UCI in the PUSCH; and processing the PUSCH with UCI multiplexed in accordance with the determination.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a conceptual diagram illustrating uplink control information (UCI) multiplexed with a physical uplink shared channel (PUSCH), in accordance with certain aspects of the present disclosure.

FIG. 6 depicts a call flow diagram for multiplexing UCI with a PUSCH, in accordance with certain aspects of the present disclosure.

FIG. 7 depicts a table outlining options for multiplexing UCI with a PUSCH, in accordance with certain aspects of the present disclosure.

FIG. 8 depicts a method for wireless communications.

FIG. 9 depicts a method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for UCI multiplexing on PUSCH with multiple code words.

One technique for transmitting uplink control information (UCI) is via multiplexing on a physical uplink shared channel (PUSCH). Certain types of UCI, such as hybrid automatic repeat request (HARQ) acknowledgment (ACK) feedback and channel state information (CSI) are typically mapped to all layers of a transport block (TB) on PUSCH. A modulation order of UCI typically follows the modulation order of the uplink (UL)-shared channel (SCH). For aperiodic CSI on PUSCH, triggered by an UL grant without UL-SCH data, the modulation order for PUSCH is typically handled the same way as the case when PUSCH is transmitted with UL-SCH data.

For UL transmissions with more than one layer, two codewords may be supported in some cases (e.g., NR Rel.18), such that PUSCH may be scheduled with two transport blocks (TBs). In such cases, each TB may have different transmission parameters (e.g., modulation and coding scheme-MCS, new data indicator-NDI, redundancy version-RV, and the like). In certain cases, PUSCH may be scheduled with less than two UL TBs. For example, PUSCH may be scheduled without UL TBs with data. In such cases, a number of coded modulation symbols per layer for a given UCI may be determined (e.g., based on a number of resource elements (REs) that are required for the given UCI and a number of REs that can be allocated for the given UCI). The potential to use two or less TBs with different transmission parameters creates potential challenges with multiplexing UCI on PUSCH.

For example, one potential challenge is how to determine how many MCSs to indicate for a PUSCH when there is no UL TB or only one UL TB. Further, determining a number of REs that may be used for UCI multiplexing and mapping the UCI content to available resources presents another challenge.

Aspects of the present disclosure, however, provide various approaches for multiplexing UCI on PUSCH with multiple codewords. The techniques provide flexible resource allocation and may help improve overall resource utilization and achieve reliable delivery of UCI.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

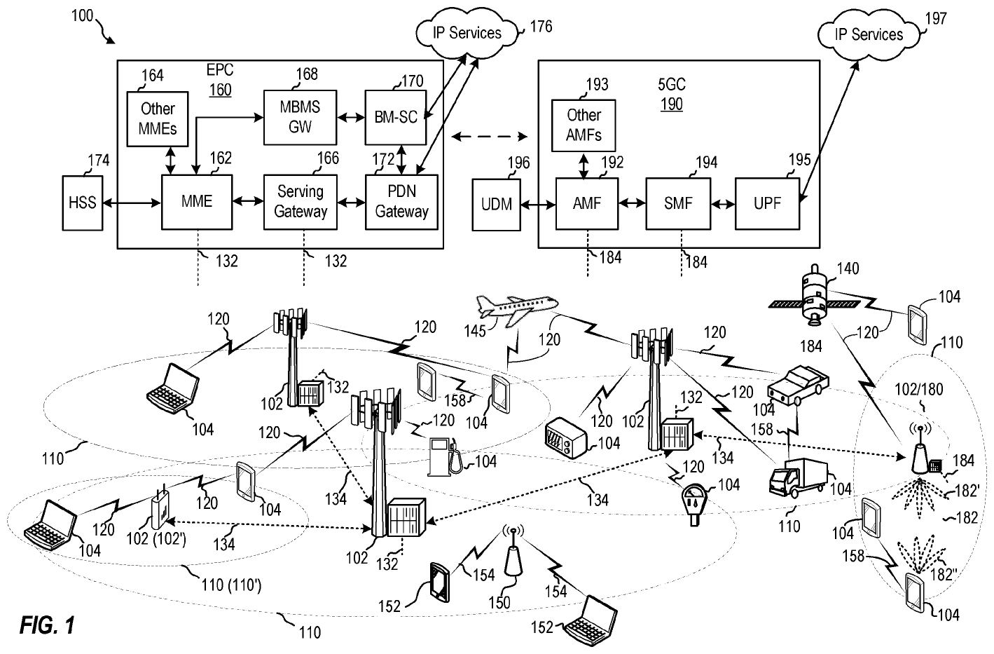

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

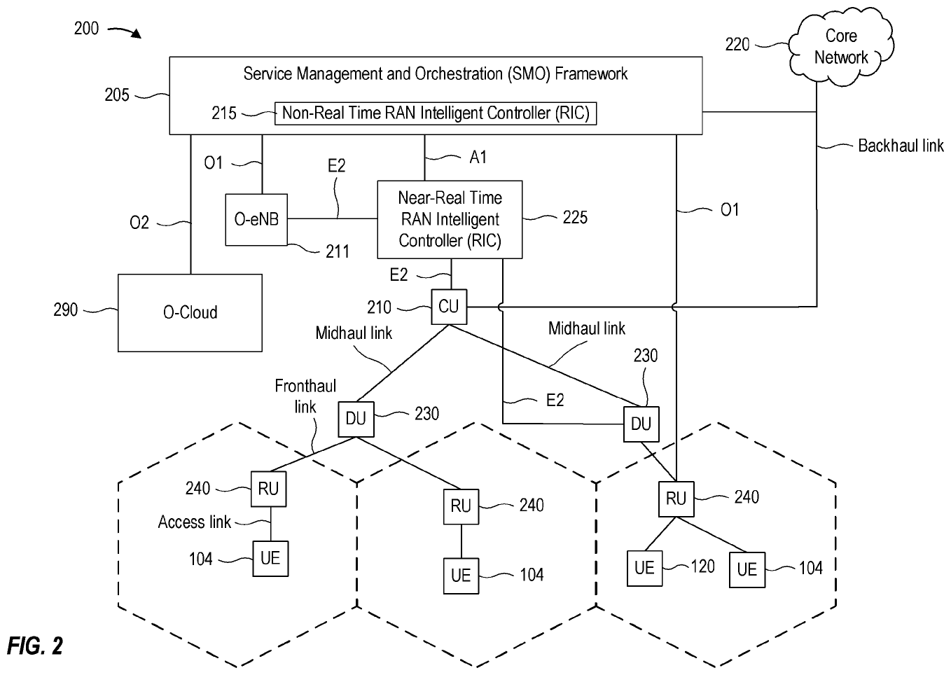

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

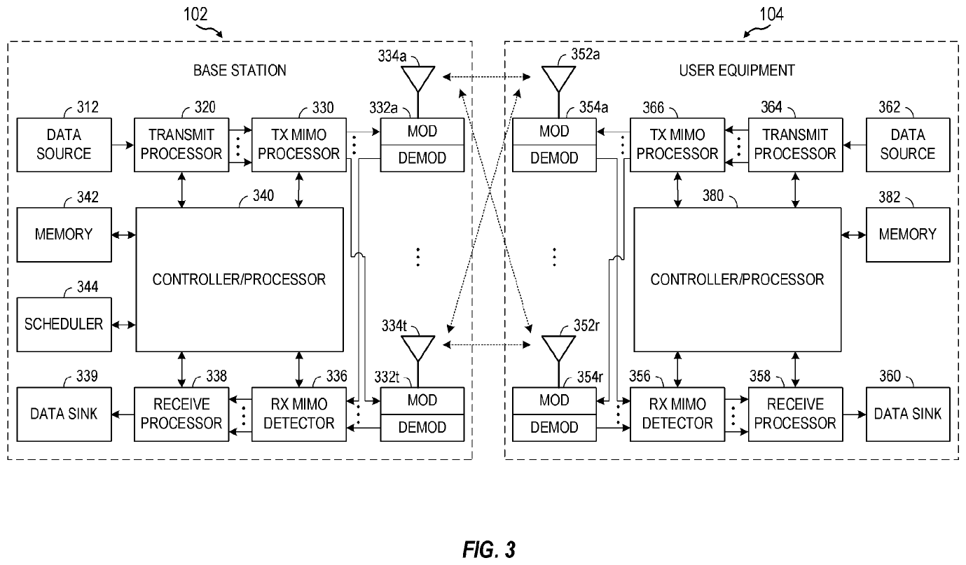

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

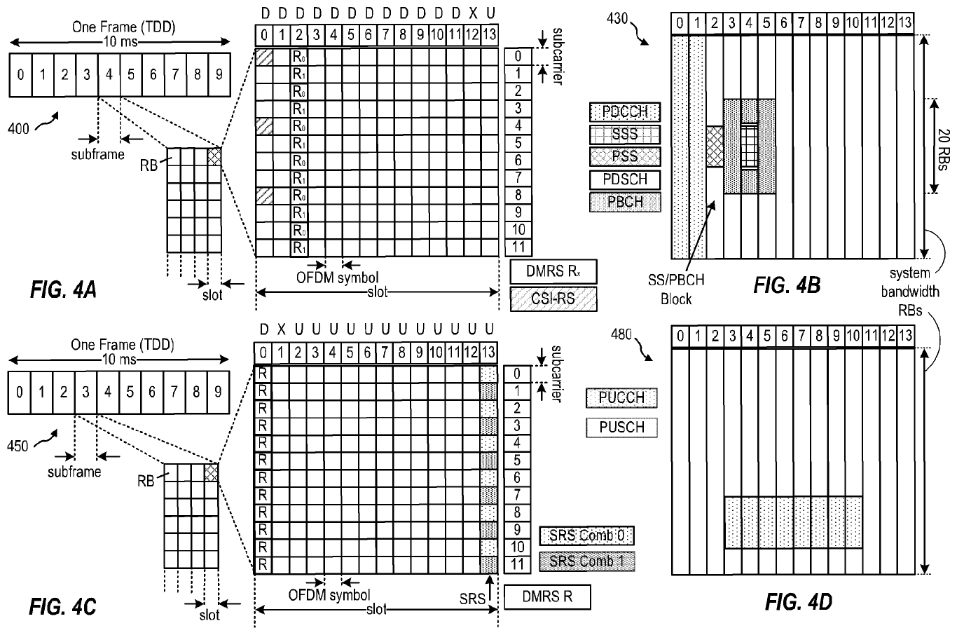

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Multiplexing UCI on PUSCH

As noted above, UCI multiplexing on PUSCH is a mechanism that allows UCI to be transmitted on PUSCH resources. Certain types of UCI, such as hybrid automatic repeat request (HARQ) acknowledgment feedback and channel state information (CSI) are typically mapped to all layers of the TB on PUSCH. Modulation order of UCI typically follows the modulation order of the UL-SCH. For aperiodic CSI on PUSCH, triggered by an UL grant without UL-SCH data, the modulation order for PUSCH is typically handled the same way as the case when PUSCH is transmitted with UL-SCH data.

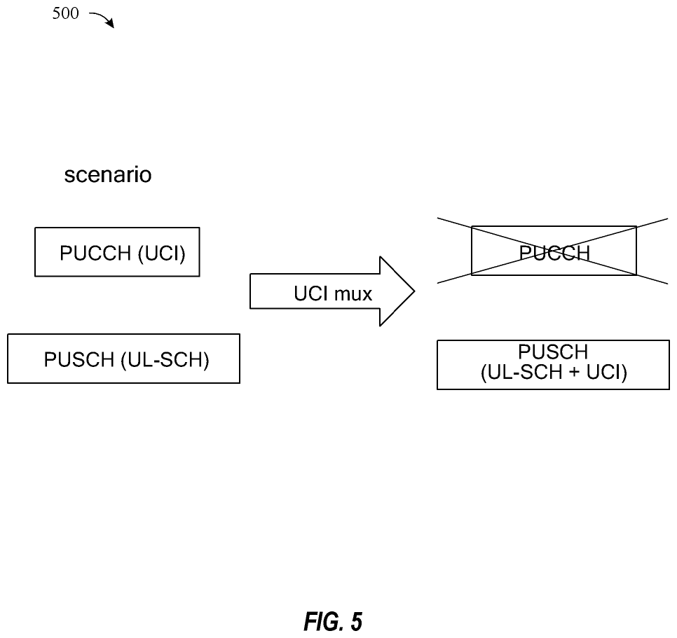

FIG. 5 is a conceptual diagram illustrating how UCI may be multiplexed with an UL data channel, in accordance with certain aspects of the present disclosure. As illustrated, UCI multiplexing on PUSCH may occur when a physical uplink control channel (PUCCH) scheduled to carry UCI overlaps (e.g., in the time domain) with a PUSCH. In this case, the PUCCH transmission may dropped and the UCI may be multiplexed on the PUSCH so that the PUSCH channel now carries data and UCI (UL-SCH+UCI).

How UCI is multiplexed may depend on the type and size of UCI content. For example, for HARQ-ACK multiplexed on PUSCH, if the payload is less than or equal to 2 bits, PUSCH may be punctured. On the other hand, for HARQ-ACK multiplexed on PUSCH, if the payload is more than 2 bits, PUSCH may be rate-matched. For a periodic CSI report configured by RRC and aperiodic CSI report triggered by UL grant, the UCI may rate-match PUSCH. For CSI multiplexing on PUSCH, CSI may be mapped to distributed REs across PUSCH allocated RBs. In some cases splitting CSI by mapping (at least for some CSI) into two parts may be supported. In such cases, the two parts may be mapped differently.

In some cases, HARQ-ACK content may be mapped to REs around demodulation reference signal (DMRS) symbol(s). Modulated HARQ-ACK symbols may be mapped starting on the first available non-DMRS symbol after the first DMRS symbol(s), regardless of number of DMRS symbols in a PUSCH transmission. Different types of CSI (e.g., CSI part 1 and CSI part 2) may be mapped starting on the first available non-DMRS symbol, regardless of number of DMRS symbols in a PUSCH.

If PUSCH is punctured by HARQ-ACK, CSI part 1 may be mapped starting after certain amount of reserved HARQ-ACK REs. CSI part 1 may not be mapped on the reserved HARQ-ACK Res. CSI part 2 may not be mapped on the CSI part 1 REs. CSI part 2 and PUSCH can be mapped to reserved HARQ-ACK REs. If PUSCH is rate matched by HARQ-ACK, HARQ-ACK may be mapped first, followed by CSI part 1. In such cases, CSI part 1 may not be mapped on the HARQ-ACK Res, while CSI part 2 may not be mapped on the HARQ-ACK REs.

One potential challenge is how to multiplex UCI on simultaneous multi-panel UL transmission. Multi-panel transmission may allow for higher UL throughput and reliability, particularly on certain frequency bands (e.g., on FR2) and multiple transmitter receiver point (mTRP) scenarios, assuming up to 2 TRPs and up to 2 panels. Uplink precoding may be indicated for PUSCH, where no new codebook is introduced for multi-panel simultaneous transmission.

In some cases, a total number of layers may be up to four across all panels and total number of codewords is up to two across all panels, considering single DCI and multi-DCI based multi-TRP operation. Such scenarios may be used to transmit UL DMRS, SRS, SRI, and TPMI (including codebook) and may enable 8 Tx UL operation to support 4 and more layers per UE in the uplink.

### Overview of Resource Determination for UCI

Time and frequency resources available for uplink control information (UCI) of different types may be determined based on a number of different equations and considerations.

For example, for hybrid automatic repeat request (HARQ)-acknowledgement (ACK) transmission on physical uplink shared channel (PUSCH) without uplink (UL)-shared channel (SCH), the number of coded modulation symbols per layer for HARQ-ACK transmission, denoted as Q′_{ACK}, may be determined as follows:

$${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ \}$$

where O_{ACK} is the number of HARQ-ACK bits; if O_{ACK} ≥360, L_{ACK}=11; otherwise L_{ACK} is the number of CRC bits for HARQ-ACK defined according to Clause 6.3.1.2.1;

$${β}_{offset}^{PUSCH} = {β}_{offset}^{HARQ - ACK} ; {M}_{sc}^{UCI} ( l )$$

is the number of resource elements that can be used for transmission of UCI in orthogonal frequency division multiplexing (OFDM) symbol l, for l=0, 1, 2, . . . ,

$${N}_{symb , all}^{PUSCH} - 1 ,$$

in the PUSCH transmission and

$${N}_{symb , all}^{PUSCH}$$

is the total number of OFDM symbols of the PUSCH, including all OFDM symbols used for demodulation reference signal (DMRS); for any OFDM symbol that carries DMRS of the PUSCH,

$${M}_{sc}^{UCI} ( l ) = 0 ;$$

for any OFDM symbol that does not carry DMRS of the PUSCH,

$${M}_{sc}^{UCI} ( l ) = {M}_{sc}^{PUSCH} - {M}_{sc}^{PT - RS} ( l ) ; {M}_{sc}^{PUSCH}$$

is the scheduled bandwidth of the PUSCH transmission, expressed as a number of subcarriers;

$${M}_{s c}^{PT - RS} ( l )$$

is the number of subcarriers in OFDM symbol l that carries phase tracking reference signal (PTRS), in the PUSCH transmission; l₀ is the symbol index of the first OFDM symbol that does not carry DMRS of the PUSCH, after the first DMRS symbol(s), in the PUSCH transmission; R is the code rate of the PUSCH, determined according to Clause 6.1.4.1 of [6, TS38.214]; Qₘ is the modulation order of the PUSCH; and α is configured by higher layer parameter scaling.

For channel state information (CSI) part 1 transmission on PUSCH without UL-SCH, the number of coded modulation symbols per layer for CSI part 1 transmission, denoted as Q′_{CSI-1}, is determined as follows. If there is CSI part 2 to be transmitted on the PUSCH,

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$$

$$else {Q}_{CSI - 1}^{′} = {\sum }_{l = 0}^{{N}_{symb , all}^{PUSCH} - 1} {M}_{sc}^{UCI} ( l ) - {Q}_{ACK}^{′}$$

where O_{CSI-1} is the number of bits for CSI part 1; if O_{CSI-1} ≥360, L_{CSI-1}=11; otherwise L_{CSI-1} is the number of CRC bits for CSI part 1 determined according to Clause 6.3.1.2.1;

$${β}_{offset}^{PUSCH} = {β}_{offset}^{CSI - part 1} ;$$

Q′_{ACK} is the number of coded modulation symbols per layer for HARQ-ACK transmitted on the PUSCH if number of HARQ-ACK information bits is more than 2, and Q′_{ACK}=

$${\sum }_{l = 0}^{{N}_{s y mb , all}^{P U S C H} - 1} {\overline{M}}_{sc , rvd}^{A C K} ( l )$$

if the number of HARQ-ACK information bits is no more than 2 bits, where

$${\overline{M}}_{sc , rvd}^{A C K} ( l )$$

is the number or reserved resource elements for potential HARQ-ACK transmission in OFDM symbol l, for l=0, 1, 2, . . . ,

$${N}_{s y mb , all}^{P U S C H} - 1$$

in the PUSCH transmission.

For CSI part 2 transmission on PUSCH without UL-SCH, the number of coded modulation symbols per layer for CSI part 2 transmission, denoted as Q′_{CSI-2}, is determined as follows:

$${Q}_{CSI - 2}^{′} = {\sum }_{l = 0}^{{N}_{s y mb , all}^{P U S C H} - 1} {M}_{s c}^{UCI} ( l ) - {Q}_{A C K}^{′} - {Q}_{CSI - 1}$$

where Q′_{ACK} is the number of coded modulation symbols per layer for HARQ-ACK transmitted on the PUSCH if number of HARQ-ACK information bits is more than 2, and Q′_{ACK}=0 if the number of HARQ-ACK information bits is 1 or 2 bits; and Q′CSI-1 is the number of coded modulation symbols per layer for CSI part 1 transmitted on the PUSCH.

When UCI is multiplexed on PUSCH without an UL transport block (TB), the number of coded modulation symbols per layer for a given uplink control information (UCI) (denoted by Q′_{UCI-type}) is calculated as follows.

For HARQ-ACK and CSI part 1 (when CSI part 2 is also multiplexed on the PUSCH), the number of coded modulation symbols per layer is calculated based on a minimum value between: 1) the number of resource elements (REs) that are required for the given UCI information (denoted by

$${Q}_{UCI - type}^{required} ) ;$$

and 2) the number of REs that can be allocated to the given UCI information (denoted by

$${Q}_{UCI - type}^{available} ) ,$$

where:

$${Q}_{ACK}^{′} = min {\{ \underbrace{⌈ \frac{( {O}_{ACK} + {L}_{ACK} ) \cdot {β}_{offset}^{PUSCH}}{R \cdot {Q}_{m}} ⌉}}_{\begin{matrix} \\ {Q}_{UCI - type}^{required}\end{matrix}} , {\underbrace{⌈ α \cdot {\sum }_{l = {l}_{0}}^{{N}_{s y mb , all}^{P U S C H} - 1} {M}_{sc}^{UCI} ( l ) ⌉} \}}_{{Q}_{UCI - type}^{available}} \\ {Q}_{CSI - 1}^{′} = min \{ \overbrace{⌈ \frac{( {O}_{CSI - 1} + {L}_{CSI - 1} ) \cdot {β}_{offset}^{PUSCH}}{R \cdot {Q}_{m}} ⌉} , \overbrace{{\sum }_{l = 0}^{{N}_{s y mb , all}^{P U S C H} - 1} {M}_{sc}^{UCI} ( l ) - {Q}_{ACK}^{′}} \} .$$

For CSI part 1 (when CSI part 2 is not multiplexed on the PUSCH) and CSI part 2, the number of coded modulation symbols per layer is calculated based on the number of REs that can be allocated to the given UCI information, i.e.,

$${Q}_{UCI - type}^{available} ,$$

where:

$${Q}_{CSI - 1}^{′} = {\underbrace{{\sum }_{l = {l}_{0}}^{{N}_{s y mb , all}^{P U S C H} - 1} {M}_{sc}^{UCI} ( l ) - {Q}_{ACK}^{′}}}_{{Q}_{UCI - type}^{available}} \\ {Q}_{CSI - 2}^{′} = {\underbrace{{\sum }_{l = 0}^{{N}_{s y mb , all}^{P U S C H} - 1} {M}_{sc}^{UCI} ( l ) - {Q}_{ACK}^{′} - {Q}_{CSI - 1}^{′}}}_{{Q}_{UCI - type}^{available}} .$$

In advanced wireless systems (e.g., Rel. 18), consideration may be given to various items to facilitate simultaneous multi-panel UL transmission for higher UL throughput/reliability, focusing on FR2 and multi-TRP, assuming up to 2 TRPs and up to 2 panels, targeting customer premises equipment (CPE)/fixed wireless access (FWA)/vehicle/industrial devices (if applicable). UL precoding indication for PUSCH, where no new codebook may be introduced for multi-panel simultaneous transmission. The total number of layers may be up to four across all panels and total number of codewords is up to two across all panels, considering single downlink control information (DCI) and multi-DCI based multi-transmit receive point (TRP) operation.

Other options may be considered, such as UL DMRS, sounding reference signal (SRS), service request indicator (SRI), and transmit precoding matrix indicator (TPMI) (including codebook) enhancements to enable 8 Tx UL operation to support 4 and more layers per UE in UL targeting PE/FWA/vehicle/Industrial devices.

### Aspects Related to UCI Multiplexing on PUSCH with Multiple Code Words

In certain systems, single codeword (CW) transmission may be supported for PUSCH. In this case, PUSCH can be scheduled with an UL TB (UL-SCH data) or without an UL TB (e.g., for CSI reporting only with no data).

In other systems, for UL transmissions (Tx) with more than 1 layer, two codewords may be supported (e.g., in Rel.18). There are various potential issues in such cases. A first potential issue is whether there is a need to indicate two modulation and coding schemes (MCSs) for a PUSCH when there is less than two UL TBs (e.g., no UL TB or when there is only single TB). A second potential issue is when UCI is multiplexed on a PUSCH without an UL TB, but with two MCSs, how to determine the number of REs that can be used for UCI multiplexing.

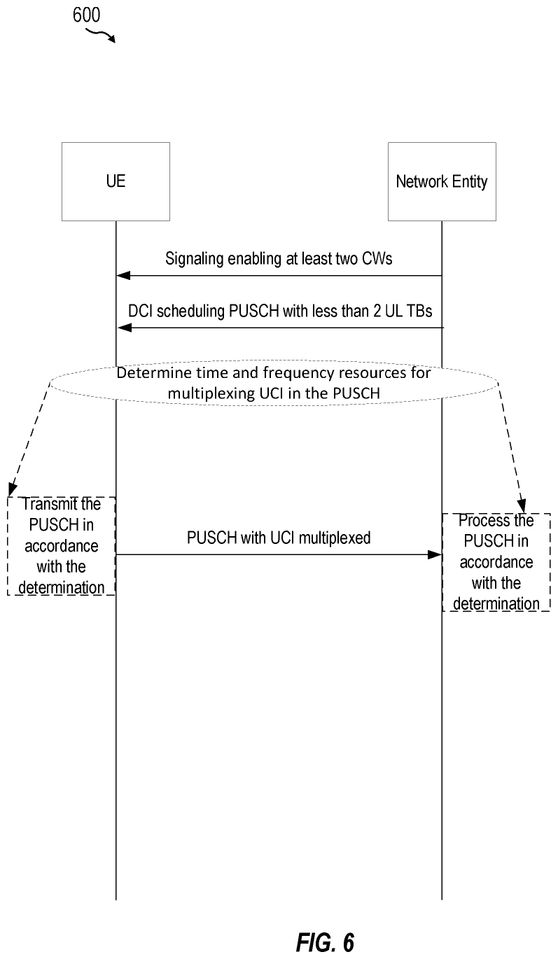

Aspects of the present disclosure provide mechanisms that may be used to address such issues, when two CWs are enable but a DCI schedules a PUSCH with less than two UL TBs. The techniques presented herein may be understood with reference to the call flow diagram 600 of FIG. 6.

As illustrated, a UE may receive, from a network entity (e.g., a gNB or node of a disaggregated base station), signaling enabling at least two code words (CWs) to be scheduled by a downlink control information (DCI). The UE may then receive the DCI scheduling a physical uplink shared channel (PUSCH) with less than two uplink transport blocks (UL TBs) with data, wherein the DCI indicates at least two MCSs for the PUSCH.

As illustrated, the UE may determine time and frequency resources for multiplexing uplink control information (UCI) in the PUSCH. The UE may then transmit the PUSCH with UCI multiplexed in accordance with the determination. The network entity, may then process the PUSCH in accordance with the determination (e.g., to demultiplex the UCI from the PUSCH).

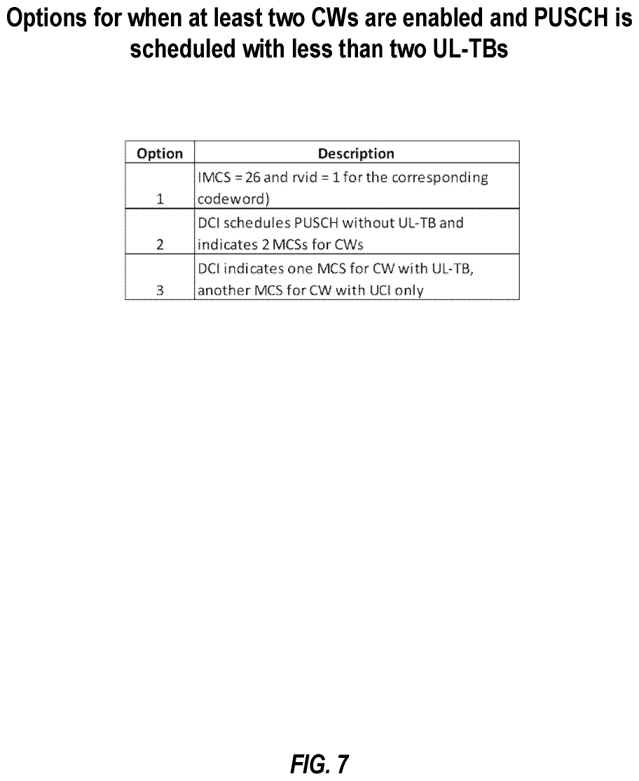

As illustrated in FIG. 7, there are various options to consider when mutliplexing UCI on PUSCH, when at least two CWs are enabled and PUSCH is scheduled with less than two UL-TBs.

According to a first option (Option 1), if a parameter maxNrofCodeWordsScheduledByDCI indicates that two codeword transmission is enabled, and if PUSCH is scheduled without a UL-TB (e.g., if a UL-SCH field is set to ‘0’), the UE may expect one of the two codewords to be disabled by DCI. For example, To disable one of the two CWs, a DCI may indicate a particular combination of parameter values (e.g., IMCS=26 and rvid=1) for the corresponding codeword. This first option basically implies that for PUSCH without UL-TB, only a single CW is supported. However, in some cases (e.g., for a large UCI payload), multiple CWs may be suitable, while different layers (CW) may have different signal to interference noise ratio (SINR) and, thus, different MCSs may be indicated.

According to a second option (Option 2), if maxNrofCodeWordsScheduledByDCI indicates that two codeword transmission is enabled, and the UE may be scheduled with a PUSCH without UL-TB (e.g., the UL-SCH field is set to ‘0’), there may be two MCSs indicated.

According to a third option (Option 3), if maxNrofCodeWordsScheduledByDCI indicates that two codeword transmission is enabled, the UE may be scheduled with a PUSCH with a single UL-TB, but may still be indicated with two MCSs. In this case, one MCS may be for one of the CWs that includes an UL TB (and may also include UCI), while the other MCS may be for another CW that only includes UCI. In such cases, 2 bits may be included in the UL-SCH field, with the following meaning:
00: UL TB is not scheduled on any CWs
01: two CWs are scheduled while UL TB is scheduled in one of the CW, e.g., the first CW.
10: two CWs are scheduled while UL TB is scheduled in one of the CW, e.g., the second CW.
11: two TBs are scheduled.

For the first option (Option 1), when UCI is multiplexed on the PUSCH without UL TB, UCI may be multiplexed on all layers of the enabled CW. For the second and third options (Options 2 and 3), when UCI is multiplexed on the PUSCH, the UCI may be multiplexed on one all layers of one of the CW, or on all layers of both CWs. Exactly how UCI multiplexing is performed may vary.

For PUSCH with two CWs but less than two TBs, one potential issue is how to determine the number of modulated symbols per layer. As noted above, for a given UCI, the number of modulated symbols per layer is determined based on at least one of the following:

The number of REs that are required for a given UCI information (denoted by

$${Q}_{UCI - type}^{required} ) ;$$

or

The number of REs that can be allocated to a given UCI information (denoted by

$${Q}_{UCI - type}^{available} ) .$$

To determine the number of REs that are required for a given UCI information (denoted by

$${Q}_{UCI - type}^{required} ) ,$$

the following options may be considered. According to a first option, the number of REs that are required for a given UCI information may be a function of: the payload size of the given UCI, e.g., O_{UCI-type}; the number of CRC bits of the given UCI, e.g., L_{UCI-type}; beta offset value of the given UCI, e.g.,

$${β}_{offset}^{PUSCH} ;$$

a nominal spectrum efficiency per layer;

$${Q}_{UCI - type}^{required} = ⌈ \frac{( {O}_{UCI - type} + {L}_{UCI - type} ) \cdot {β}_{offset}^{P U S C H}}{nominal SE per layer} ⌉$$

wherein nominal spectral efficiency (SE) is the number of bits that can be nominally transmitted per layer which can be calculated based on one of the following alternatives. According to a first alternative,

$$nominal SE per layer = {R}^{( x )} \cdot {Q}_{m}^{( x )}$$

where x is the enabled CW; R^{(x)} is the code rate of the enabled CW;

$${Q}_{m}^{( x )}$$

is the modulation order of the enabled CW. This alternative may be applied for Option 1 (e.g., when PUSCH is scheduled w/o UL TB and only single CW is enabled).

According to a second alternative (Alt.2):

$$nominal SE per layer = {w}_{1} \cdot {R}^{( 1 )} \cdot {Q}_{m}^{( 1 )} + {w}_{2} \cdot {R}^{( 2 )} \cdot {Q}_{m}^{( 2 )} ;$$

where R⁽¹⁾ and R⁽²⁾ are the code rate of the first CW and the second CW, respectively;

$${Q}_{m}^{( 1 )} and {Q}_{m}^{( 2 )}$$

are the modulation order of the first CW and the second CW, respectively; w₁ and w₂ are the scaling factor for the first CW and second CW, respectively. In some cases, w₁ and w₂ may be fixed value. In other cases, w₁ and w₂ are predefined based on some rule, such as:

$${w}_{1} = \frac{{N}_{L}^{( 1 )}}{{N}_{L}^{( 1 )} + {N}_{L}^{( 2 )}} and {w}_{2} = \frac{{N}_{L}^{( 2 )}}{{N}_{L}^{( 1 )} + {N}_{L}^{( 2 )}}$$

where

$${N}_{L}^{( 1 )} and {N}_{L}^{( 2 )}$$

are the number of layers mapped to the first CW and the second CW, respectively. In some cases, w₁ and w₂ may be configured by RRC. In other cases,

$$nominal SE per layer = {R}^{( x )} \cdot {Q}_{m}^{( x )}$$

where

$${R}^{( x )} \cdot {Q}_{m}^{( x )}$$

is the maximum or minimum product of code rate and modulation order among the two CWs. These alternatives may be applied for option 2 described above (e.g., when PUSCH is scheduled w/o UL TB and two MCSs are indicated).

According to one option, the number of REs that are required for a given UCI information is a function of the payload size of the given UCI, e.g., O_{UCI-type}; the number of CRC bits of the given UCI, e.g., L_{UCI-type}; beta offset value of the given UCI, e.g.,

$${β}_{offset}^{P U S C H} ;$$

nominal spectrum efficiency (SE); and

$${Q}_{UCI - type}^{required} = ⌈ \frac{( {O}_{UCI - type} + {L}_{UCI - type} ) \cdot {β}_{offset}^{P U S C H}}{nominal SE per layer} ⌉$$

wherein nominal SE is the number of bits that can be nominally transmitted per RE which can be calculated based on one of the following:

$$nominal SE = {R}^{( x )} \cdot {Q}_{m}^{( x )} \cdot {N}_{L}^{( x )}$$

where x is the enabled CW; R^{(x)} is the code rate of the enabled CW;

$${Q}_{m}^{( x )}$$

is the modulation order of the enabled CW;

$${N}_{L}^{( x )}$$

is the number of layers mapped to the enabled CW. This approach may be applied, for example, when PUSCH is scheduled w/o UL TB and only single CW is enabled.

In some cases,

$$nominal S E = {R}^{( 1 )} \cdot {Q}_{m}^{( 1 )} \cdot {N}_{L}^{( 1 )} + {R}^{( 2 )} \cdot {Q}_{m}^{( 2 )} \cdot {N}_{L}^{( 2 )}$$

where R⁽¹⁾ and R⁽²⁾ are the code rate of the first CW and the second CW, respectively;

$${Q}_{m}^{( 1 )} and {Q}_{m}^{( 2 )}$$

are the modulation order of the first CW and the second CW, respectively; and

$${N}_{L}^{( 1 )} and {N}_{L}^{( 2 )}$$

are the number of layers mapped to the first CW and the second CW, respectively.

According to another alternative, nominal SE may calculated as follows:

$$nominal SE = {R}^{( x )} \cdot {Q}_{m}^{( x )} \cdot ( {N}_{L}^{( 1 )} + {N}_{L}^{( 2 )} ) ,$$

where R^{(x)} is the code rate of CW x and Qu is the modulation order of CW x, where CW x is the CW with maximum or minimum

$${R}^{( x )} \cdot {Q}_{m}^{( x )} ; and {N}_{L}^{( 1 )} and {N}_{L}^{( 2 )}$$

are the number of layers mapped to the first CW and the second CW, respectively.

According to another alternative, nominal SE may calculated as:

$$nominal SE = {R}^{( x )} \cdot ( {Q}_{m}^{( 1 )} \cdot {N}_{L}^{( 1 )} + {Q}_{m}^{( 2 )} \cdot {N}_{L}^{( 2 )} )$$

where R^{(x)} is the coding rate corresponding to a particular MCS. The particular MCS can be the first MCS, or the largest/smallest MCS, or the MCS with lower/higher code rate.

$${Q}_{m}^{( 1 )} and {Q}_{m}^{( 2 )}$$

may be the modulation order of the first CW and the second CW, respectively.

$${N}_{L}^{( 1 )} and {N}_{L}^{( 2 )}$$

are the number of layers mapped to the first CW and the second CW, respectively.

These alternatives may be applied when PUSCH is scheduled w/o UL TB and two MCSs are indicated.

According to another approach, nominal SE may be calculated as follows:

$$nominal SE = {\sum }_{r = 0}^{{C}_{UL - SCH}^{( x )} - 1} {K}_{r}^{( x )} / {\sum }_{l = 0}^{{N}_{symb , all}^{PUSCH} - 1} {M}_{sc}^{UCI} ( l ) + {R}^{( y )} \cdot {Q}_{m}^{( y )} \cdot {N}_{L}^{( y )} , or$$

$$nominal SE = R \cdot {Q}_{m} \cdot ( {N}_{L}^{( x )} + {N}_{L}^{( y )} ) , where$$

$$R \cdot {Q}_{m} = max \{ {\sum }_{r = 0}^{{C}_{UL - SCH}^{( x )} - 1} {K}_{r}^{( x )} / \{ {\sum }_{l = 0}^{{N}_{symb , all}^{PUSCH} - 1} {M}_{SC}^{UCI} ( l ) \cdot {N}_{L}^{( x )} ) , {R}^{( y )} \cdot {Q}_{m}^{( y )} \} or$$

$$min \{ {\sum }_{r = 0}^{{C}_{UL - SCH}^{( x )} - 1} {K}_{r}^{( x )} / \{ {\sum }_{l = 0}^{{N}_{symb , all}^{PUSCH} - 1} {M}_{SC}^{UCI} ( l ) \cdot {N}_{L}^{( x )} ) , {R}^{( y )} \cdot {Q}_{m}^{( y )} \} .$$

$${C}_{UL - SCH}^{( x )}$$

may refer to the number of code blocks for UL TB on the PUSCH transmission corresponding to CW x and Kᵣ is the r-th code block size for UL TB on the PUSCH transmission corresponding to the CW x. In such cases,

$${M}_{sc}^{UCI} ( l )$$

may be the number of resource elements that can be used for transmission of UCI in OFDM symbol l, for l=0, 1, 2, . . . ,

$${N}_{symb , all}^{PUSCH} - 1 ,$$

in the PUSCH transmission and

$${N}_{symb , all}^{PUSCH}$$

is the total number of OFDM symbols of the PUSCH, including all OFDM symbols used for DMRS. For any OFDM symbol that carries DMRS of the PUSCH,

$${M}_{sc}^{UCI} ( l ) = 0 ,$$

where for any OFDM symbol that does not carry DMRS of the PUSCH,

$${M}_{sc}^{UCI} ( l ) = {M}_{sc}^{PUSCH} - {M}_{sc}^{PT - RS} ( l ) .$$

R^{(y)} is the code rate of CW y,

$${Q}_{m}^{( y )}$$

is the modulation order of CW y and

$${N}_{L}^{( x )} and {N}_{L}^{( y )}$$

are the number of layers mapped to CW x and CW y, respectively. According to one or materials, for example, The techniques described here one time. These alternatives may be applied when PUSCH is scheduled w/single UL TB and two MCSs are indicated.

According to another option (e.g., Option 2-2), the number of REs that are required for a given UCI information may be a function of various parameters: the payload size of the given UCI, e.g., O_{UCI-type}; the number of CRC bits of the given UCI, e.g., L_{UCI-type}; per-CW beta offset value of the given UCI, e.g.,

$${β}_{offset , 1}^{PUSCH} and {β}_{offset , 2}^{P U S C H} ;$$

and per-CW nominal spectrum efficiency (SE); where

$${Q}_{UCI - type}^{required} = ⌈ \frac{( {O}_{UCI - type} + {L}_{UCI - type} )}{\frac{SE 1}{{β}_{offset , 1}^{PUSCH}} + \frac{SE 2}{{β}_{offset , 2}^{PUSCH}}} ⌉$$

and wherein

$${β}_{offset , 1}^{PUSCH} and {β}_{offset , 2}^{PUSCH}$$

is the beta offset configured or indicated for first CW and second CW, respectively. In this case, SE1 is the nominal SE of the first CW and SE2 is the nominal SE of the second CW, which can be calculated based on one of the following alternatives. According to a first alternative:

$$SE 1 = {R}^{( 1 )} \cdot {Q}_{m}^{( 1 )} \cdot {N}_{L}^{( 1 )} , SE 2 = {R}^{( 2 )} \cdot {Q}_{m}^{( 2 )} \cdot {N}_{L}^{( 2 )}$$

where R⁽¹⁾ and R⁽²⁾ are the code rate of the first CW and the second CW, respectively;

$${Q}_{m}^{( 1 )} and {Q}_{m}^{( 2 )}$$

are the modulation order of the first CW and the second CW, respectively; and

$${N}_{L}^{( 1 )} and {N}_{L}^{( 2 )}$$

are the number of layers mapped to the first CW and the second CW, respectively. This alternative may be applied, for example, when PUSCH is scheduled w/o UL TB and two MCSs are indicated.

According to another alternative (Alt.2):

$$SE 1 = {R}^{( x )} \cdot {Q}_{m}^{( 1 )} \cdot {N}_{L}^{( 1 )} , SE 2 = {R}^{( x )} \cdot {Q}_{m}^{( 2 )} \cdot {N}_{L}^{( 2 )}$$

where

$${Q}_{m}^{( 1 )} and {Q}_{m}^{( 2 )}$$

are the modulation order of the first CW and the second CW, respectively; and

$${N}_{L}^{( 1 )} and {N}_{L}^{( 2 )}$$

are the number of layers mapped to the first CW and the second CW, respectively. R^{(x)} is the coding rate corresponding to a particular MCS. The particular MCS can be the first MCS, or the largest/smallest MCS, or the MCS with lower/higher code rate. This Alt. 2 approach may be applicable to the first option described above, when PUSCH is scheduled without UL TB and two MCSs are indicated.

According to another alternative (Alt.3):

$$SE 1 = {\sum }_{r = 0}^{{C}_{UL − {SCH}^{- 1}}^{( x )}} {K}_{r}^{( x )} / {\sum }_{l = 0}^{{N}_{symb , all}^{PUSCH} − 1} {M}_{sc}^{UCI} ( l ) , SE 2 = {R}^{( y )} \cdot {Q}_{m}^{( y )} \cdot {N}_{L}^{( y )}$$

where x is the CW with UL TB, y is the CW w/o UL TB;

$${C}_{UL - SCH}^{( x )}$$

is the number of code blocks for UL TB on the PUSCH transmission corresponding to CW x and Kᵣ is the r-th code block size for UL TB on the PUSCH transmission corresponding to the CW x; and

$${M}_{s c}^{UCI} ( l )$$

is the number of resource elements that can be used for transmission of UCI in OFDM symbol l, for l=0, 1, 2, . . . ,

$${N}_{symb , all}^{PUSCH} - 1 ,$$

in the PUSCH transmission and

$${N}_{symb , all}^{PUSCH}$$

is the total number of OFDM symbols of the PUSCH, including all OFDM symbols used for DMRS. In some cases, for any OFDM symbol that carries DMRS of the PUSCH,

$${M}_{sc}^{UCI} ( l ) = 0 ;$$

while for any OFDM symbol that does not carry DMRS of the PUSCH,

$${M}_{sc}^{UCI} ( l ) = {N}_{sc}^{PUSCH} - {M}_{sc}^{PT - RS} ( l ) .$$

R^{(y)} is the code rate of CW y,

$${Q}_{m}^{( y )}$$

is the modulation order of CW y,

$${N}_{L}^{( y )}$$

is the number or layers mapped to CW y.

The alternative described above may be applied for option 3 in the proposal 1 above (i.e., when PUSCH is scheduled w/single UL TB and two MCSs are indicated).

In some cases, to determine the number of REs that can be allocated to a given UCI, the following can be considered.

According to one option (Option 2-1), the number of REs that can be allocated to a given UCI is determined by excluding the number of REs that has been allocated to other UCIs regardless of whether other UCI is multiplexed on the same CW or not as the given UCI. The available resources for Q, may be as follows:

$${Q}_{given - UCI}^{available} = [ α \cdot {\sum }_{l = 0}^{{N}_{symb , all}^{PUSCH} − 1} {M}_{sc}^{UCI} ( l ) ] − {Q}_{OtherUCIs}^{( x )}$$

where α is a fixed value (e.g. 1) or configured by RRC,

$${Q}_{OtherUCIs}^{( x )}$$

is the number of REs that has been allocated to other UCIs.

$${Q}_{O therUCIs}^{( x )} = 0$$

if other UCIs are not multiplexed on the PUSCH that the given UCI is multiplexed.

In some cases, how UCI is transmitted may depend on other factors. For example, if the given UCI is CSI part 1, other UCIs correspond to HARQ-ACK. If the given UCI part is for CSI part 2, other UCIs correspond to HARQ-ACK and CSI part 1.

In some cases, the number of REs that can be allocated to a given UCI may determined by excluding the number of REs that has been allocated to other UCIs when other UCIs are multiplexed on the same CW that the given UCI is multiplexed on. In this context,

$${Q}_{O therUCIs}^{( x )}$$

refers to me as the number of REs that has been allocated to other UCIs if other UCI is also multiplexed on the CW that the given UCI is multiplexed.

$${Q}_{O t herUCIs}^{( x )} = 0$$

if other UCI is not multiplexed on the CW that the given UCI is multiplexed. If the given UCI is CSI part 1, other UCIs correspond to HARQ-ACK. If the given UCI is CSI part 2, other UCIs correspond to HARQ-ACK and CSI part 1.

Based on techniques proposed above, the UE can determine the number of modulated symbols per layer for a given UCI, e.g., denoted by Q′_{UCI}. Then the UE determines the number of coded UCI bits based on the number of modulated symbols per layer.

According to one option, the number of coded UCI bits E_{UCI} based on the following:

$${E}_{UCI} = {Q}_{UCI}^{′} \cdot {Q}_{m}^{( x )} \cdot {N}_{L}^{( x )}$$

where Q′_{UCI} is the number of modulated symbols per layer for a given UCI,

$${Q}_{m}^{( x )}$$

is the modulation order of the CW on which the given UCI is multiplexed, and

$${N}_{L}^{( x )}$$

is the number of layers mapped to the CW on which the given UCI is multiplexed. This option may be applied when a given UCI is multiplexed on all layers of a single CW.

According to another option:

$${E}_{UCI} = {Q}_{UCI}^{′} \cdot ( {Q}_{m}^{( 1 )} \cdot {N}_{L}^{( 1 )} + {Q}_{m}^{( 2 )} \cdot {N}_{L}^{( 2 )} ) ,$$

where Q′_{UCI} is the number of modulated symbols per layer for a given UCI,

$${Q}_{m}^{( 1 )} and {Q}_{m}^{( 2 )}$$

is the modulation order of the first CW and the second CW, respectively, and

$${N}_{L}^{( 1 )} and {N}_{L}^{( 2 )}$$

is the number of layers mapped to the first CW and second CW, respectively. This option may be applied when a given UCI is multiplexed on all layers of both CWs.

### Example Operations of a User Equipment

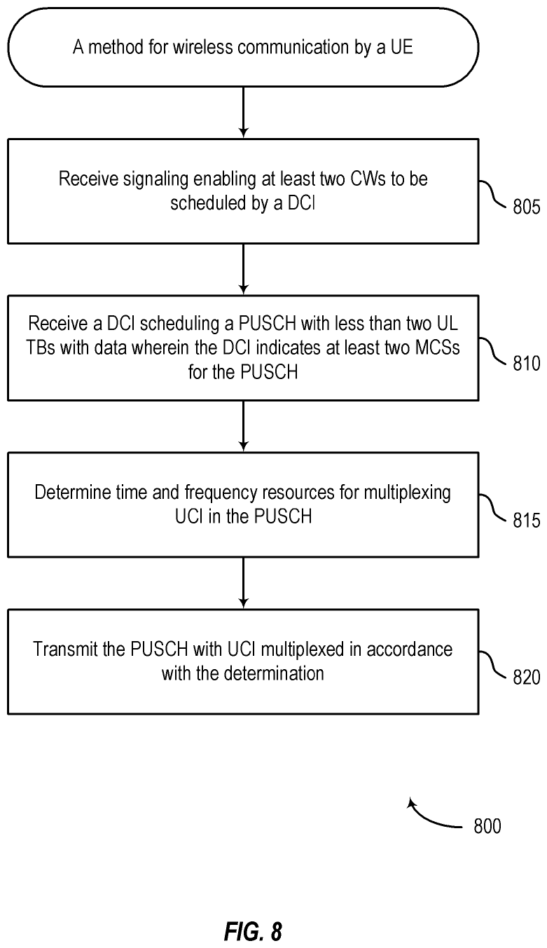

FIG. 8 shows an example of a method 800 for wireless communication by a UE, such as a UE 104 of FIGS. 1 and 3.

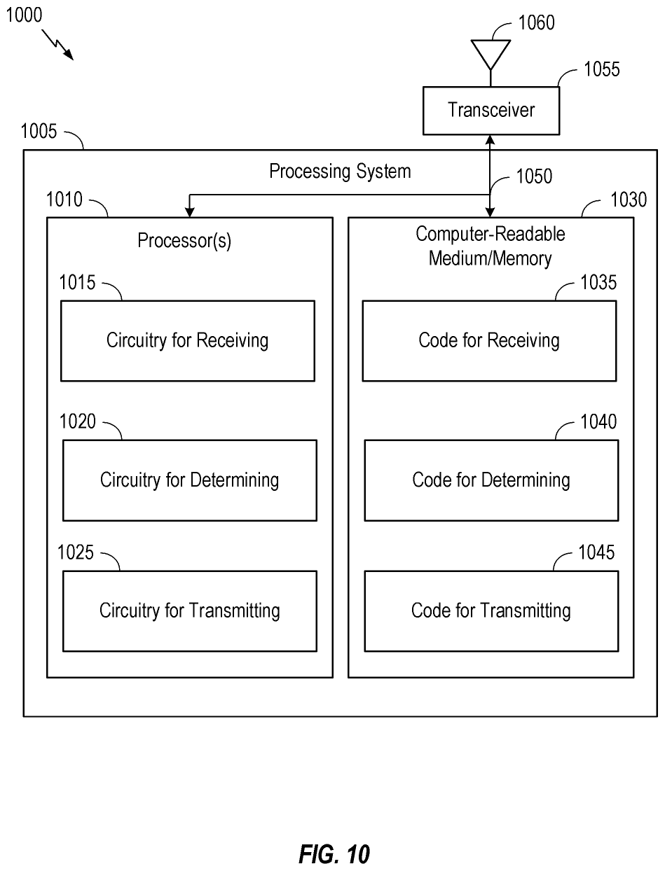

Method 800 begins at step 805 with receiving signaling enabling at least two CWs to be scheduled by a DCI. In some cases, the operations of this step refer to, or may be performed by, circuitry for receiving and/or code for receiving as described with reference to FIG. 10.

Method 800 then proceeds to step 810 with receiving a DCI scheduling a PUSCH with less than two UL TBs with data wherein the DCI indicates at least two MCSs for the PUSCH. In some cases, the operations of this step refer to, or may be performed by, circuitry for receiving and/or code for receiving as described with reference to FIG. 10.

Method 800 then proceeds to step 815 with determining time and frequency resources for multiplexing UCI in the PUSCH. In some cases, the operations of this step refer to, or may be performed by, circuitry for determining and/or code for determining as described with reference to FIG. 10.

Method 800 then proceeds to step 820 with transmitting the PUSCH with UCI multiplexed in accordance with the determination. In some cases, the operations of this step refer to, or may be performed by, circuitry for transmitting and/or code for transmitting as described with reference to FIG. 10.

In some aspects, the DCI schedules the PUSCH without UL TBs with data; and one of the at least two CWs is disabled and one of the at least two CWs is enabled.

In some aspects, determining the time and frequency resources for multiplexing the UCI in the PUSCH comprises: determining a number of REs required for a given type of UCI based, at least in part, on a nominal SE per layer, wherein the nominal SE per layer depends, at least in part on a code rate of the enabled CW and a modulation order of the enabled CW.

In some aspects, the nominal SE also depends on a number of layers mapped to the enabled CW.

In some aspects, the DCI schedules the PUSCH without UL TBs with data; and the DCI indicates MCSs for at least first and second CWs of the at least two CWs.

In some aspects, determining the time and frequency resources for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

In some aspects, the first scaling factor and the second scaling factor are determined based on at least one of fixed values, one or more predefined rules, or RRC configuration.

In some aspects, determining the time and frequency resources for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

In some aspects, determining the time and frequency resources for multiplexing the UCI in the PUSCH comprises: determining a number of REs required for a given type of UCI based, at least in part, on a nominal SE per RE calculated as a sum of: a first product of a code rate of the first CW, a modulation order of the first CW, and a number of layers mapped to the first CW; and a second product of a code rate of the second CW, a modulation order of the second CW, and a number of layers mapped to the second CW.

In some aspects, determining the time and frequency resources for multiplexing the UCI in the PUSCH comprises: determining a number of REs required for a given type of UCI based, at least in part, on a nominal SE per RE calculated as a product of: a code rate of a CW from the first CW and the second CW, wherein the CW is the CW with maximum or minimum product of a code rate and a modulation order; a modulation order of the CW from the first CW and the second CW; and a sum of a number of layers mapped to the first CW and a number of layers mapped to the second CW.

In some aspects, determining the time and frequency resources for multiplexing the UCI in the PUSCH comprises: determining a number of REs required for a given type of UCI based, at least in part, on a nominal SE per RE calculated as a product of: a code rate of a CW from the first CW and the second CW wherein the CW corresponds to a particular MCS; and a sum of a product of a modulation order of the first CW and a number of layers mapped to the first CW, and a product of a modulation order of the second CW and a number of layers mapped to the second CW.

In some aspects, the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

In some aspects, the DCI includes an UL-SCH field with one or more bits to indicate in which CWs of the first CW and the second CW a UL-TB is scheduled.

In some aspects, determining the time and frequency resources for multiplexing the UCI in the PUSCH comprises: determining a number of REs required for a given type of UCI based, at least in part, on a first nominal SE of the first CW and a second nominal SE of the second CW.

In some aspects, the first nominal SE is calculated as a first product of a code rate of the first CW, a modulation order of the first CW, and a number of layers mapped to the first CW; and the second nominal SE is calculated as a second product of a code rate of the second CW, a modulation order of the second CW, and a number of layers mapped to the second CW.

In some aspects, the first nominal SE is calculated as a first product of a modulation order of the first CW, a number of layers mapped to the first CW, and a code rate associated with a particular MCS of the first CW or the second CW; the second nominal SE is calculated as a second product of a modulation order of the second CW, a number of layers mapped to the second CW, and the code rate associated with a particular MCS of the first CW or the second CW; and the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

In some aspects, the DCI schedules the PUSCH with one UL TB included in a CW of the first CW and the second CW and UCI only in another CW of the first CW and the second CW; and the DCI indicates MCSs for the first and second CWs.

In some aspects, determining the time and frequency resources for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

In some aspects, the first scaling factor and the second scaling factor are determined based on at least one of fixed values, one or more predefined rules, or RRC configuration.

In some aspects, determining the time and frequency resources for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

In some aspects, determining the time and frequency resources for multiplexing the UCI in the PUSCH comprises: determining a number of REs required for a given type of UCI based, at least in part, on a nominal SE per RE depends on at least one of: a summation of code block sizes over code blocks for the UL TB; or a summation of a number of REs that can be used for UCI over symbols of the PUSCH.

In some aspects, determining the time and frequency resources for multiplexing the UCI in the PUSCH comprises determining a number of REs required for a given type of UCI based, at least in part, on: a first nominal SE of the first CW that depends on at least one of: a summation of code block sizes over code blocks for the UL TB or a summation of a number of REs that can be used for UCI over symbols of the PUSCH; and a second nominal SE of the second CW calculated as a product of a code rate of the second CW, a modulation order of the second CW and a number of layers mapped to the second CW.

In some aspects, determining the time and frequency resources for multiplexing the UCI in the PUSCH further comprises: determining a number of REs available for a given type of UCI based, at least in part, on a number of REs that have been allocated to other UCIs, independently of whether the other UCIs are multiplexed on a same CW.

In some aspects, determining the time and frequency resources for multiplexing the UCI in the PUSCH further comprises: determining a number of REs available for a given type of UCI based, at least in part, on a number of REs that have been allocated to other UCIs on a same CW.

In some aspects, determining the time and frequency resources for multiplexing the UCI in the PUSCH comprises determining a number of coded UCI bits based on a number of modulated symbols per layer.

In some aspects, the number of coded bits is determined as a product of: a number of modulated symbols per layer for a given UCI; a modulation order of the CW on which the given UCI is multiplexed; and a number of layers mapped to the CW on which the given UCI is multiplexed.

In some aspects, the number of coded bits is determined as a product of: a number of modulated symbols per layer for a given UCI; and a sum of a first product of a modulation order of a first CW and a number of layers mapped to the first CW, and a second product of a modulation order of a second CW and a number of layers mapped to the second CW.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Operations of a Network Entity

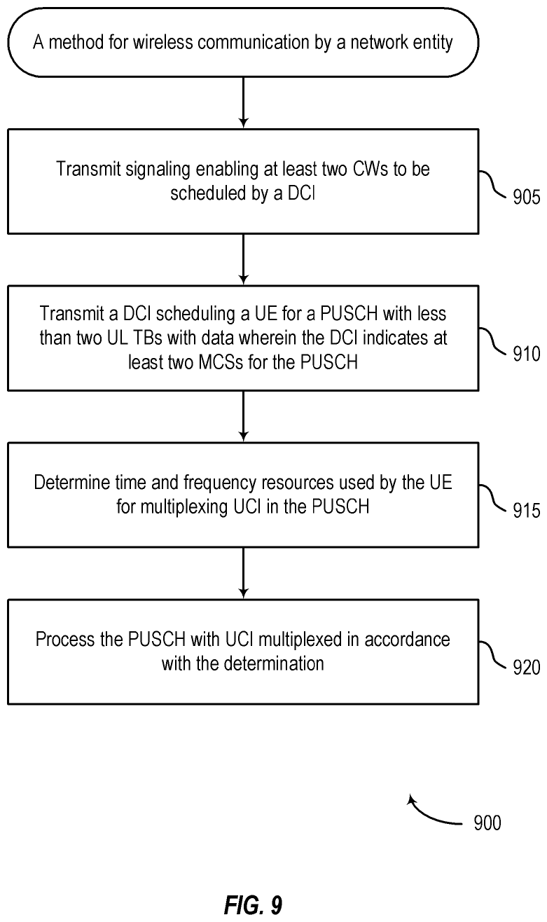

FIG. 9 shows an example of a method 900 for wireless communication by a network entity, such as a BS 102 of FIGS. 1 and 3, or a disaggregated base station as discussed with respect to FIG. 2.

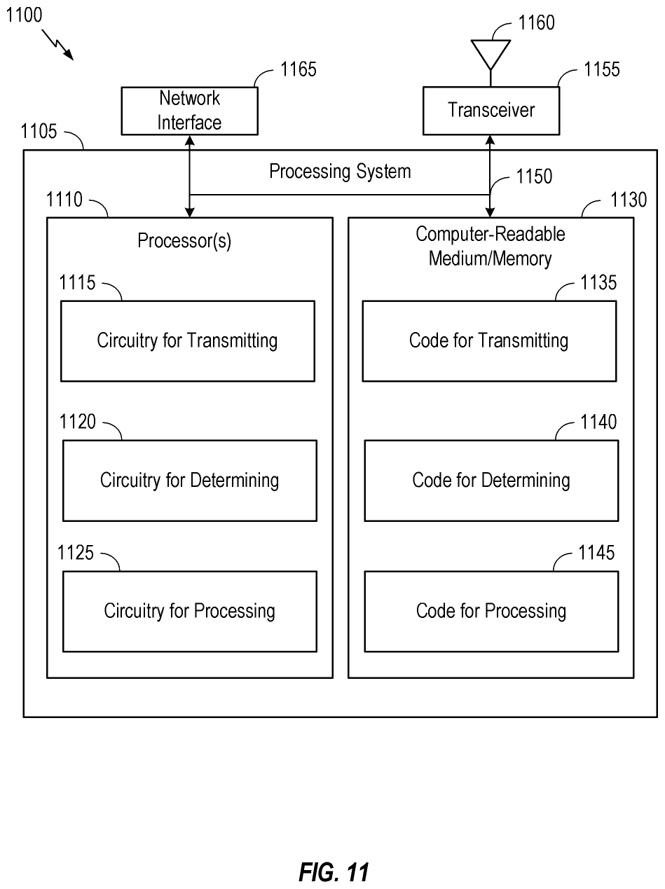

Method 900 begins at step 905 with transmitting signaling enabling at least two CWs to be scheduled by a DCI. In some cases, the operations of this step refer to, or may be performed by, circuitry for transmitting and/or code for transmitting as described with reference to FIG. 11.

Method 900 then proceeds to step 910 with transmitting a DCI scheduling a UE for a PUSCH with less than two UL TBs with data wherein the DCI indicates at least two MCSs for the PUSCH. In some cases, the operations of this step refer to, or may be performed by, circuitry for transmitting and/or code for transmitting as described with reference to FIG. 11.

Method 900 then proceeds to step 915 with determining time and frequency resources used by the UE for multiplexing UCI in the PUSCH. In some cases, the operations of this step refer to, or may be performed by, circuitry for determining and/or code for determining as described with reference to FIG. 11.

Method 900 then proceeds to step 920 with processing the PUSCH with UCI multiplexed in accordance with the determination. In some cases, the operations of this step refer to, or may be performed by, circuitry for processing and/or code for processing as described with reference to FIG. 11.

In some aspects, the DCI schedules the PUSCH without UL TBs with data; and one of the at least two CWs is disabled and one of the at least two CWs is enabled.

In some aspects, determining time and frequency resources used by the UE for multiplexing UCI in the PUSCH comprises: determining a number of REs required for a given type of UCI based, at least in part, on a nominal SE per layer, wherein the nominal SE per layer depends, at least in part on a code rate of the enabled CW and a modulation order of the enabled CW.

In some aspects, the nominal SE also depends on a number of layers mapped to the enabled CW.

In some aspects, the DCI schedules the PUSCH without UL TBs with data; and the DCI indicates MCSs for at least first and second CWs of the at least two CWs.

In some aspects, determining time and frequency resources used by the UE for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

In some aspects, the first scaling factor and the second scaling factor are determined based on at least one of fixed values, one or more predefined rules, or RRC configuration.

In some aspects, determining time and frequency resources used by the UE for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

In some aspects, determining time and frequency resources used by the UE for multiplexing the UCI in the PUSCH comprises: determining a number of REs required for a given type of UCI based, at least in part, on a nominal SE per RE calculated as a sum of: a first product of a code rate of the first CW, a modulation order of the first CW, and a number of layers mapped to the first CW; and a second product of a code rate of the second CW, a modulation order of the second CW, and a number of layers mapped to the second CW.

In some aspects, determining time and frequency resources used by the UE for multiplexing the UCI in the PUSCH comprises: determining a number of REs required for a given type of UCI based, at least in part, on a nominal SE per RE calculated as a product of: a code rate of a CW from the first CW and the second CW, wherein the CW is the CW with maximum or minimum product of a code rate and a modulation order; a modulation order of the CW from the first CW and the second CW; and a sum of a number of layers mapped to the first CW and a number of layers mapped to the second CW.

In some aspects, determining time and frequency resources used by the UE for multiplexing the UCI in the PUSCH comprises: determining a number of REs required for a given type of UCI based, at least in part, on a nominal SE per RE calculated as a product of: a code rate of a CW from the first CW and the second CW wherein the CW corresponds to a particular MCS; and a sum of a product of a modulation order of the first CW and a number of layers mapped to the first CW, and a product of a modulation order of the second CW and a number of layers mapped to the second CW.

In some aspects, the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

In some aspects, the DCI includes an UL-SCH field with one or more bits to indicate in which CWs of the first CW and the second CW a UL-TB is scheduled.

In some aspects, determining time and frequency resources used by the UE for multiplexing the UCI in the PUSCH comprises: determining a number of REs required for a given type of UCI based, at least in part, on a first nominal SE of the first CW and a second nominal SE of the second CW.

In some aspects, the first nominal SE is calculated as a first product of a code rate of the first CW, a modulation order of the first CW, and a number of layers mapped to the first CW; and the second nominal SE is calculated as a second product of a code rate of the second CW, a modulation order of the second CW, and a number of layers mapped to the second CW.

In some aspects, the first nominal SE is calculated as a first product of a modulation order of the first CW, a number of layers mapped to the first CW, and a code rate associated with a particular MCS of the first CW or the second CW; the second nominal SE is calculated as a second product of a modulation order of the second CW, a number of layers mapped to the second CW, and the code rate associated with a particular MCS of the first CW or the second CW; and the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

In some aspects, the DCI schedules the PUSCH with one UL TB included in a CW of the first CW and the second CW and UCI only in another CW of the first CW and the second CW; and the DCI indicates MCSs for the first and second CWs.

In some aspects, determining time and frequency resources used by the UE for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

In some aspects, the first scaling factor and the second scaling factor are determined based on at least one of fixed values, one or more predefined rules, or RRC configuration.

In some aspects, determining time and frequency resources used by the UE for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

In some aspects, determining time and frequency resources used by the UE for multiplexing the UCI in the PUSCH comprises: determining a number of REs required for a given type of UCI based, at least in part, on a nominal SE per RE depends on at least one of: a summation of code block sizes over code blocks for the UL TB; or a summation of a number of REs that can be used for UCI over symbols of the PUSCH.

In some aspects, determining time and frequency resources used by the UE for multiplexing the UCI in the PUSCH comprises determining a number of REs required for a given type of UCI based, at least in part, on: a first nominal SE of the first CW that depends on at least one of: a summation of code block sizes over code blocks for the UL TB or a summation of a number of REs that can be used for UCI over symbols of the PUSCH; and a second nominal SE of the second CW calculated as a product of a code rate of the second CW, a modulation order of the second CW and a number of layers mapped to the second CW.

In some aspects, determining time and frequency resources used by the UE for multiplexing the UCI in the PUSCH further comprises: determining a number of REs available for a given type of UCI based, at least in part, on a number of REs that have been allocated to other UCIs, independently of whether the other UCIs are multiplexed on a same CW.

In some aspects, determining time and frequency resources used by the UE for multiplexing the UCI in the PUSCH further comprises: determining a number of REs available for a given type of UCI based, at least in part, on a number of REs that have been allocated to other UCIs on a same CW.

In some aspects, determining time and frequency resources used by the UE for multiplexing the UCI in the PUSCH comprises determining a number of coded UCI bits based on a number of modulated symbols per layer.

In some aspects, the number of coded bits is determined as a product of: a number of modulated symbols per layer for a given UCI; a modulation order of the CW on which the given UCI is multiplexed; and a number of layers mapped to the CW on which the given UCI is multiplexed.

In some aspects, the number of coded bits is determined as a product of: a number of modulated symbols per layer for a given UCI; and a sum of a first product of a modulation order of a first CW and a number of layers mapped to the first CW, and a second product of a modulation order of a second CW and a number of layers mapped to the second CW.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Communications Devices

FIG. 10 depicts aspects of an example communications device 1000. In some aspects, communications device 1000 is a user equipment, such as a UE 104 described above with respect to FIGS. 1 and 3.

The communications device 1000 includes a processing system 1005 coupled to the transceiver 1055 (e.g., a transmitter and/or a receiver). The transceiver 1055 is configured to transmit and receive signals for the communications device 1000 via the antenna 1060, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, cause the one or more processors 1010 to perform the method 800 described with respect to FIG. 8, or any aspect related to it. Note that reference to a processor performing a function of communications device 1000 may include one or more processors 1010 performing that function of communications device 1000.

In the depicted example, computer-readable medium/memory 1030 stores code (e.g., executable instructions), such as code for receiving 1035, code for determining 1040, and code for transmitting 1045. Processing of the code for receiving 1035, code for determining 1040, and code for transmitting 1045 may cause the communications device 1000 to perform the method 800 described with respect to FIG. 8, or any aspect related to it.

The one or more processors 1010 include circuitry configured to implement (e.g., execute) the code stored in the computer-readable medium/memory 1030, including circuitry such as circuitry for receiving 1015, circuitry for determining 1020, and circuitry for transmitting 1025. Processing with circuitry for receiving 1015, circuitry for determining 1020, and circuitry for transmitting 1025 may cause the communications device 1000 to perform the method 800 described with respect to FIG. 8, or any aspect related to it.

Various components of the communications device 1000 may provide means for performing the method 800 described with respect to FIG. 8, or any aspect related to it. For example, means for transmitting, sending or outputting for transmission may include transceivers 354 and/or antenna(s) 352 of the UE 104 illustrated in FIG. 3 and/or the transceiver 1055 and the antenna 1060 of the communications device 1000 in FIG. 10. Means for receiving or obtaining may include transceivers 354 and/or antenna(s) 352 of the UE 104 illustrated in FIG. 3 and/or the transceiver 1055 and the antenna 1060 of the communications device 1000 in FIG. 10.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to the transceiver 1155 (e.g., a transmitter and/or a receiver) and/or a network interface 1165. The transceiver 1155 is configured to transmit and receive signals for the communications device 1100 via the antenna 1160, such as the various signals as described herein. The network interface 1165 is configured to obtain and send signals for the communications device 1100 via communication link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 900 described with respect to FIG. 9, or any aspect related to it. Note that reference to a processor of communications device 1100 performing a function may include one or more processors 1110 of communications device 1100 performing that function.

In the depicted example, the computer-readable medium/memory 1130 stores code (e.g., executable instructions), such as code for transmitting 1135, code for determining 1140, and code for processing 1145. Processing of the code for transmitting 1135, code for determining 1140, and code for processing 1145 may cause the communications device 1100 to perform the method 900 described with respect to FIG. 9, or any aspect related to it.

The one or more processors 1110 include circuitry configured to implement (e.g., execute) the code stored in the computer-readable medium/memory 1130, including circuitry such as circuitry for transmitting 1115, circuitry for determining 1120, and circuitry for processing 1125. Processing with circuitry for transmitting 1115, circuitry for determining 1120, and circuitry for processing 1125 may cause the communications device 1100 to perform the method 900 as described with respect to FIG. 9, or any aspect related to it.

Various components of the communications device 1100 may provide means for performing the method 900 as described with respect to FIG. 9, or any aspect related to it. Means for transmitting, sending or outputting for transmission may include transceivers 332 and/or antenna(s) 334 of the BS 102 illustrated in FIG. 3 and/or the transceiver 1155 and the antenna 1160 of the communications device 1100 in FIG. 11. Means for receiving or obtaining may include transceivers 332 and/or antenna(s) 334 of the BS 102 illustrated in FIG. 3 and/or the transceiver 1155 and the antenna 1160 of the communications device 1100 in FIG. 11.

### Example Clauses

Implementation examples are described in the following numbered clauses:

Clause 1: A method for wireless communication by a UE, comprising: receiving signaling enabling at least two CWs to be scheduled by a DCI; receiving a DCI scheduling a PUSCH with less than two UL TBs with data wherein the DCI indicates at least two MCSs for the PUSCH; determining time and frequency resources for multiplexing UCI in the PUSCH; and transmitting the PUSCH with UCI multiplexed in accordance with the determination.

Clause 2: The method of Clause 1, wherein: the DCI schedules the PUSCH without UL TBs with data; and one of the at least two CWs is disabled and one of the at least two CWs is enabled.

Clause 3: The method of Clause 2, wherein determining the time and frequency resources for multiplexing the UCI in the PUSCH comprises: determining a number of REs required for a given type of UCI based, at least in part, on a nominal SE per layer, wherein the nominal SE per layer depends, at least in part on a code rate of the enabled CW and a modulation order of the enabled CW.

Clause 4: The method of Clause 3, wherein the nominal SE also depends on a number of layers mapped to the enabled CW.

Clause 5: The method of any one of Clauses 1-4, wherein: the DCI schedules the PUSCH without UL TBs with data; and the DCI indicates MCSs for at least first and second CWs of the at least two CWs.

Clause 6: The method of Clause 5, wherein determining the time and frequency resources for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

Clause 7: The method of Clause 6, wherein the first scaling factor and the second scaling factor are determined based on at least one of fixed values, one or more predefined rules, or RRC configuration.

Clause 8: The method of Clause 5, wherein determining the time and frequency resources for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

Clause 9: The method of Clause 5, wherein determining the time and frequency resources for multiplexing the UCI in the PUSCH comprises: determining a number of REs required for a given type of UCI based, at least in part, on a nominal SE per RE calculated as a sum of: a first product of a code rate of the first CW, a modulation order of the first CW, and a number of layers mapped to the first CW; and a second product of a code rate of the second CW, a modulation order of the second CW, and a number of layers mapped to the second CW.

Clause 10: The method of Clause 5, wherein determining the time and frequency resources for multiplexing the UCI in the PUSCH comprises: determining a number of REs required for a given type of UCI based, at least in part, on a nominal SE per RE calculated as a product of: a code rate of a CW from the first CW and the second CW, wherein the CW is the CW with maximum or minimum product of a code rate and a modulation order; a modulation order of the CW from the first CW and the second CW; and a sum of a number of layers mapped to the first CW and a number of layers mapped to the second CW.

Clause 11: The method of Clause 5, wherein determining the time and frequency resources for multiplexing the UCI in the PUSCH comprises: determining a number of REs required for a given type of UCI based, at least in part, on a nominal SE per RE calculated as a product of: a code rate of a CW from the first CW and the second CW wherein the CW corresponds to a particular MCS; and a sum of a product of a modulation order of the first CW and a number of layers mapped to the first CW, and a product of a modulation order of the second CW and a number of layers mapped to the second CW.

Clause 12: The method of Clause 11, wherein the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

Clause 13: The method of Clause 12, wherein the DCI includes an UL-SCH field with one or more bits to indicate in which CWs of the first CW and the second CW a UL-TB is scheduled.

Clause 14: The method of Clause 5, wherein determining the time and frequency resources for multiplexing the UCI in the PUSCH comprises: determining a number of REs required for a given type of UCI based, at least in part, on a first nominal SE of the first CW and a second nominal SE of the second CW.

Clause 15: The method of Clause 14, wherein: the first nominal SE is calculated as a first product of a code rate of the first CW, a modulation order of the first CW, and a number of layers mapped to the first CW; and the second nominal SE is calculated as a second product of a code rate of the second CW, a modulation order of the second CW, and a number of layers mapped to the second CW.

Clause 16: The method of Clause 14, wherein: the first nominal SE is calculated as a first product of a modulation order of the first CW, a number of layers mapped to the first CW, and a code rate associated with a particular MCS of the first CW or the second CW; the second nominal SE is calculated as a second product of a modulation order of the second CW, a number of layers mapped to the second CW, and the code rate associated with a particular MCS of the first CW or the second CW; and the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

Clause 17: The method of Clause 5, wherein: the DCI schedules the PUSCH with one UL TB included in a CW of the first CW and the second CW and UCI only in another CW of the first CW and the second CW; and the DCI indicates MCSs for the first and second CWs.

Clause 18: The method of Clause 17, wherein determining the time and frequency resources for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

Clause 19: The method of Clause 18, wherein the first scaling factor and the second scaling factor are determined based on at least one of fixed values, one or more predefined rules, or RRC configuration.

Clause 20: The method of Clause 17, wherein determining the time and frequency resources for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

Clause 21: The method of Clause 17, wherein determining the time and frequency resources for multiplexing the UCI in the PUSCH comprises: determining a number of REs required for a given type of UCI based, at least in part, on a nominal SE per RE depends on at least one of: a summation of code block sizes over code blocks for the UL TB; or a summation of a number of REs that can be used for UCI over symbols of the PUSCH.

Clause 22: The method of Clause 17, wherein determining the time and frequency resources for multiplexing the UCI in the PUSCH comprises determining a number of REs required for a given type of UCI based, at least in part, on: a first nominal SE of the first CW that depends on at least one of: a summation of code block sizes over code blocks for the UL TB or a summation of a number of REs that can be used for UCI over symbols of the PUSCH; and a second nominal SE of the second CW calculated as a product of a code rate of the second CW, a modulation order of the second CW and a number of layers mapped to the second CW.

Clause 23: The method of any one of Clauses 1-22, wherein determining the time and frequency resources for multiplexing the UCI in the PUSCH further comprises: determining a number of REs available for a given type of UCI based, at least in part, on a number of REs that have been allocated to other UCIs, independently of whether the other UCIs are multiplexed on a same CW.

Clause 24: The method of any one of Clauses 1-23, wherein determining the time and frequency resources for multiplexing the UCI in the PUSCH further comprises: determining a number of REs available for a given type of UCI based, at least in part, on a number of REs that have been allocated to other UCIs on a same CW.

Clause 25: The method of any one of Clauses 1-24, wherein determining the time and frequency resources for multiplexing the UCI in the PUSCH comprises determining a number of coded UCI bits based on a number of modulated symbols per layer.

Clause 26: The method of Clause 25, wherein the number of coded bits is determined as a product of: a number of modulated symbols per layer for a given UCI; a modulation order of the CW on which the given UCI is multiplexed; and a number of layers mapped to the CW on which the given UCI is multiplexed.

Clause 27: The method of Clause 25, wherein the number of coded bits is determined as a product of: a number of modulated symbols per layer for a given UCI; and a sum of a first product of a modulation order of a first CW and a number of layers mapped to the first CW, and a second product of a modulation order of a second CW and a number of layers mapped to the second CW.

Clause 28: A method for wireless communication by a network entity, comprising: transmitting signaling enabling at least two CWs to be scheduled by a DCI; transmitting a DCI scheduling a UE for a PUSCH with less than two UL TBs with data wherein the DCI indicates at least two MCSs for the PUSCH; determining time and frequency resources used by the UE for multiplexing UCI in the PUSCH; and processing the PUSCH with UCI multiplexed in accordance with the determination.

Clause 29: The method of Clause 28, wherein: the DCI schedules the PUSCH without UL TBs with data; and one of the at least two CWs is disabled and one of the at least two CWs is enabled.

Clause 30: The method of Clause 29, wherein determining time and frequency resources used by the UE for multiplexing UCI in the PUSCH comprises: determining a number of REs required for a given type of UCI based, at least in part, on a nominal SE per layer, wherein the nominal SE per layer depends, at least in part on a code rate of the enabled CW and a modulation order of the enabled CW.

Clause 31: The method of Clause 30, wherein the nominal SE also depends on a number of layers mapped to the enabled CW.

Clause 32: The method of any one of Clauses 28-31, wherein: the DCI schedules the PUSCH without UL TBs with data; and the DCI indicates MCSs for at least first and second CWs of the at least two CWs.

Clause 33: The method of Clause 32, wherein determining time and frequency resources used by the UE for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

Clause 34: The method of Clause 33, wherein the first scaling factor and the second scaling factor are determined based on at least one of fixed values, one or more predefined rules, or RRC configuration.

Clause 35: The method of Clause 32, wherein determining time and frequency resources used by the UE for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

Clause 36: The method of Clause 32, wherein determining time and frequency resources used by the UE for multiplexing the UCI in the PUSCH comprises: determining a number of REs required for a given type of UCI based, at least in part, on a nominal SE per RE calculated as a sum of: a first product of a code rate of the first CW, a modulation order of the first CW, and a number of layers mapped to the first CW; and a second product of a code rate of the second CW, a modulation order of the second CW, and a number of layers mapped to the second CW.

Clause 37: The method of Clause 32, wherein determining time and frequency resources used by the UE for multiplexing the UCI in the PUSCH comprises: determining a number of REs required for a given type of UCI based, at least in part, on a nominal SE per RE calculated as a product of: a code rate of a CW from the first CW and the second CW, wherein the CW is the CW with maximum or minimum product of a code rate and a modulation order; a modulation order of the CW from the first CW and the second CW; and a sum of a number of layers mapped to the first CW and a number of layers mapped to the second CW.

Clause 38: The method of Clause 32, wherein determining time and frequency resources used by the UE for multiplexing the UCI in the PUSCH comprises: determining a number of REs required for a given type of UCI based, at least in part, on a nominal SE per RE calculated as a product of: a code rate of a CW from the first CW and the second CW wherein the CW corresponds to a particular MCS; and a sum of a product of a modulation order of the first CW and a number of layers mapped to the first CW, and a product of a modulation order of the second CW and a number of layers mapped to the second CW.

Clause 39: The method of Clause 38, wherein the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

Clause 40: The method of Clause 39, wherein the DCI includes an UL-SCH field with one or more bits to indicate in which CWs of the first CW and the second CW a UL-TB is scheduled.

Clause 41: The method of Clause 32, wherein determining time and frequency resources used by the UE for multiplexing the UCI in the PUSCH comprises: determining a number of REs required for a given type of UCI based, at least in part, on a first nominal SE of the first CW and a second nominal SE of the second CW.

Clause 42: The method of Clause 41, wherein: the first nominal SE is calculated as a first product of a code rate of the first CW, a modulation order of the first CW, and a number of layers mapped to the first CW; and the second nominal SE is calculated as a second product of a code rate of the second CW, a modulation order of the second CW, and a number of layers mapped to the second CW.

Clause 43: The method of Clause 41, wherein: the first nominal SE is calculated as a first product of a modulation order of the first CW, a number of layers mapped to the first CW, and a code rate associated with a particular MCS of the first CW or the second CW; the second nominal SE is calculated as a second product of a modulation order of the second CW, a number of layers mapped to the second CW, and the code rate associated with a particular MCS of the first CW or the second CW; and the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

Clause 44: The method of Clause 32, wherein: the DCI schedules the PUSCH with one UL TB included in a CW of the first CW and the second CW and UCI only in another CW of the first CW and the second CW; and the DCI indicates MCSs for the first and second CWs.

Clause 45: The method of Clause 44, wherein determining time and frequency resources used by the UE for multiplexing the UCI in the PUSCH comprises: determining a number of REs required for a given type of UCI based, at least in part, on a nominal SE per layer calculated as a sum of: a first product of a code rate of the first CW, a modulation order of the first CW, and a first scaling factor; and a second product of a code rate of the second CW, a modulation order of the second CW, and a second scaling factor.

Clause 46: The method of Clause 45, wherein the first scaling factor and the second scaling factor are determined based on at least one of fixed values, one or more predefined rules, or RRC configuration.

Clause 47: The method of Clause 44, wherein determining time and frequency resources used by the UE for multiplexing the UCI in the PUSCH comprises: determining a number of REs required for a given type of UCI based, at least in part, on a nominal SE per layer calculated as a maximum or minimum of: a first product of a code rate of the first CW and a modulation order of the first CW; and a second product of a code rate of the second CW and a modulation order of the second CW.

Clause 48: The method of Clause 44, wherein determining time and frequency resources used by the UE for multiplexing the UCI in the PUSCH comprises: determining a number of REs required for a given type of UCI based, at least in part, on a nominal SE per RE depends on at least one of: a summation of code block sizes over code blocks for the UL TB; or a summation of a number of REs that can be used for UCI over symbols of the PUSCH.

Clause 49: The method of Clause 44, wherein determining time and frequency resources used by the UE for multiplexing the UCI in the PUSCH comprises determining a number of REs required for a given type of UCI based, at least in part, on: a first nominal SE of the first CW that depends on at least one of: a summation of code block sizes over code blocks for the UL TB or a summation of a number of REs that can be used for UCI over symbols of the PUSCH; and a second nominal SE of the second CW calculated as a product of a code rate of the second CW, a modulation order of the second CW and a number of layers mapped to the second CW.

Clause 50: The method of any one of Clauses 28-49, wherein determining time and frequency resources used by the UE for multiplexing the UCI in the PUSCH further comprises: determining a number of REs available for a given type of UCI based, at least in part, on a number of REs that have been allocated to other UCIs, independently of whether the other UCIs are multiplexed on a same CW.

Clause 51: The method of any one of Clauses 28-50, wherein determining time and frequency resources used by the UE for multiplexing the UCI in the PUSCH further comprises: determining a number of REs available for a given type of UCI based, at least in part, on a number of REs that have been allocated to other UCIs on a same CW.

Clause 52: The method of any one of Clauses 28-51, wherein determining time and frequency resources used by the UE for multiplexing the UCI in the PUSCH comprises determining a number of coded UCI bits based on a number of modulated symbols per layer.

Clause 53: The method of Clause 52, wherein the number of coded bits is determined as a product of: a number of modulated symbols per layer for a given UCI; a modulation order of the CW on which the given UCI is multiplexed; and a number of layers mapped to the CW on which the given UCI is multiplexed.

Clause 54: The method of Clause 52, wherein the number of coded bits is determined as a product of: a number of modulated symbols per layer for a given UCI; and a sum of a first product of a modulation order of a first CW and a number of layers mapped to the first CW, and a second product of a modulation order of a second CW and a number of layers mapped to the second CW.

Clause 55: An apparatus, comprising: a memory comprising executable instructions; and a processor configured to execute the executable instructions and cause the apparatus to perform a method in accordance with any one of Clauses 1-54.

Clause 56: An apparatus, comprising means for performing a method in accordance with any one of Clauses 1-54.

Clause 57: A non-transitory computer-readable medium comprising executable instructions that, when executed by a processor of an apparatus, cause the apparatus to perform a method in accordance with any one of Clauses 1-54.

Clause 58: A computer program product embodied on a computer-readable storage medium comprising code for performing a method in accordance with any one of Clauses 1-54.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication by a user equipment (UE), comprising:
receiving signaling enabling at least two code words (CWs) to be scheduled by a downlink control information (DCI);
receiving a DCI scheduling a physical uplink shared channel (PUSCH) with less than two uplink (UL) transport blocks (TBs) with data wherein the DCI indicates at least two modulation and coding schemes (MCSs) for the PUSCH;
determining time and frequency resources for multiplexing uplink control information (UCI) in the PUSCH; and
transmitting the PUSCH with UCI multiplexed in accordance with the determination.

2. The method of claim 1, wherein:
the DCI schedules the PUSCH without UL TBs with data; and
one of the at least two CWs is disabled and one of the at least two CWs is enabled.

3. The method of claim 2, wherein determining the time and frequency resources for multiplexing the UCI in the PUSCH comprises:
determining a number of resource elements (REs) required for a given type of UCI based, at least in part, on a nominal spectral efficiency (SE) per layer, wherein the nominal SE per layer depends, at least in part on a code rate of the enabled CW and a modulation order of the enabled CW.

4. The method of claim 3, wherein the nominal SE also depends on a number of layers mapped to the enabled CW.

5. The method of claim 1, wherein:
the DCI schedules the PUSCH without UL TBs with data; and
the DCI indicates MCSs for at least first and second CWs of the at least two CWs.

6. The method of claim 5, wherein determining the time and frequency resources for multiplexing the UCI in the PUSCH comprises:
determining a number of resource elements (REs) required for a given type of UCI based, at least in part, on a nominal spectral efficiency (SE) per layer calculated as a sum of:
a first product of a code rate of the first CW, a modulation order of the first CW, and a first scaling factor; and
a second product of a code rate of the second CW, a modulation order of the second CW, and a second scaling factor.

7. The method of claim 6, wherein the first scaling factor and the second scaling factor are determined based on at least one of fixed values, one or more predefined rules, or radio resource control (RRC) configuration.

8. The method of claim 5, wherein determining the time and frequency resources for multiplexing the UCI in the PUSCH comprises:
determining a number of resource elements (REs) required for a given type of UCI based, at least in part, on a nominal spectral efficiency (SE) per layer calculated as a maximum or minimum of:
a first product of a code rate of the first CW and a modulation order of the first CW; and
a second product of a code rate of the second CW and a modulation order of the second CW.

9. The method of claim 5, wherein determining the time and frequency resources for multiplexing the UCI in the PUSCH comprises:
determining a number of resource elements (REs) required for a given type of UCI based, at least in part, on a nominal spectral efficiency (SE) per RE calculated as a sum of:
a first product of a code rate of the first CW, a modulation order of the first CW, and a number of layers mapped to the first CW; and
a second product of a code rate of the second CW, a modulation order of the second CW, and a number of layers mapped to the second CW.

10. The method of claim 5, wherein determining the time and frequency resources for multiplexing the UCI in the PUSCH comprises:
determining a number of resource elements (REs) required for a given type of UCI based, at least in part, on a nominal spectral efficiency (SE) per RE calculated as a product of:
a code rate of a CW from the first CW and the second CW, wherein the CW is the CW with maximum or minimum product of a code rate and a modulation order;
a modulation order of the CW from the first CW and the second CW; and
a sum of a number of layers mapped to the first CW and a number of layers mapped to the second CW.

11. The method of claim 5, wherein determining the time and frequency resources for multiplexing the UCI in the PUSCH comprises:
determining a number of resource elements (REs) required for a given type of UCI based, at least in part, on a nominal spectral efficiency (SE) per RE calculated as a product of:
a code rate of a CW from the first CW and the second CW wherein the CW corresponds to a particular MCS; and
a sum of a product of a modulation order of the first CW and a number of layers mapped to the first CW, and
a product of a modulation order of the second CW and a number of layers mapped to the second CW.

12. The method of claim 11, where the particular MCS is at least one of:
an MCS of the first CW,
the largest MCS of the at least two MCSs,
the smallest MCS of the at least two MCSs,
the MCS, of the at least two MCSs, with a smaller code rate, and
the MCS, of the at least two MCSs, with a higher code rate.

13. The method of claim 5, wherein determining the time and frequency resources for multiplexing the UCI in the PUSCH comprises:
determining a number of resource elements (REs) required for a given type of UCI based, at least in part, on a first nominal spectral efficiency (SE) of the first CW and a second nominal SE of the second CW.

14. The method of claim 13, wherein:
the first nominal SE is calculated as a first product of a code rate of the first CW, a modulation order of the first CW, and a number of layers mapped to the first CW; and
The second nominal SE is calculated as a second product of a code rate of the second CW, a modulation order of the second CW, and a number of layers mapped to the second CW.

15. The method of claim 13, wherein:
the first nominal SE is calculated as a first product of a modulation order of the first CW, a number of layers mapped to the first CW, and a code rate associated with a particular modulation and coding scheme (MCS) of the first CW or the second CW;
the second nominal SE is calculated as a second product of a modulation order of the second CW, a number of layers mapped to the second CW, and the code rate associated with a particular MCS of the first CW or the second CW; and
the particular MCS is at least one of: an MCS of the first CW, the largest MCS of the at least two MCSs, the smallest MCS of the at least two MCSs, the MCS, of the at least two MCSs, with a smaller code rate, and the MCS, of the at least two MCSs, with a higher code rate.

16. The method of claim 5, wherein:
the DCI schedules the PUSCH with one UL TB included in a CW of the first CW and the second CW and UCI only in another CW of the first CW and the second CW; and
the DCI indicates modulation and coding schemes (MCSs) for the first and second CWs.

17. The method of claim 12, wherein the DCI includes an UL-shared channel (UL-SCH) field with one or more bits to indicate in which CWs of the first CW and the second CW a UL-TB is scheduled.

18. The method of claim 16, wherein determining the time and frequency resources for multiplexing the UCI in the PUSCH comprises:
determining a number of resource elements (REs) required for a given type of UCI based, at least in part, on a nominal spectral efficiency (SE) per layer calculated as a sum of:
A first product of a code rate of the first CW, a modulation order of the first CW, and a first scaling factor; and
A second product of a code rate of the second CW, a modulation order of the second CW, and a second scaling factor.

19. The method of claim 18, wherein the first scaling factor and the second scaling factor are determined based on at least one of fixed values, one or more predefined rules, or radio resource control (RRC) configuration.

20. The method of claim 16, wherein determining the time and frequency resources for multiplexing the UCI in the PUSCH comprises:
determining a number of resource elements (REs) required for a given type of UCI based, at least in part, on a nominal spectral efficiency (SE) per layer calculated as a maximum or minimum of:
A first product of a code rate of the first CW and a modulation order of the first CW; and
A second product of a code rate of the second CW and a modulation order of the second CW.

21. The method of claim 16, wherein determining the time and frequency resources for multiplexing the UCI in the PUSCH comprises:
determining a number of resource elements (REs) required for a given type of UCI based, at least in part, on a nominal spectral efficiency (SE) per RE depends on at least one of:
A summation of code block sizes over code blocks for the UL TB; or
A summation of a number of REs that can be used for UCI over symbols of the PUSCH.

22. The method of claim 16, wherein determining the time and frequency resources for multiplexing the UCI in the PUSCH comprises determining a number of resource elements (REs) required for a given type of UCI based, at least in part, on:
a first nominal spectral efficiency (SE) of the first CW that depends on at least one of: a summation of code block sizes over code blocks for the UL TB or a summation of a number of REs that can be used for UCI over symbols of the PUSCH; and
a second nominal SE of the second CW calculated as a product of a code rate of the second CW, a modulation order of the second CW and a number of layers mapped to the second CW.

23. The method of claim 1, wherein determining the time and frequency resources for multiplexing the UCI in the PUSCH further comprises:
determining a number of resource elements (REs) available for a given type of UCI based, at least in part, on a number of REs that have been allocated to other UCIs, independently of whether the other UCIs are multiplexed on a same CW.

24. The method of claim 1, wherein determining the time and frequency resources for multiplexing the UCI in the PUSCH further comprises:
determining a number of resource elements (REs) available for a given type of UCI based, at least in part, on a number of REs that have been allocated to other UCIs on a same CW.

25. The method of claim 1, wherein determining the time and frequency resources for multiplexing the UCI in the PUSCH comprises determining a number of coded UCI bits based on a number of modulated symbols per layer.

26. The method of claim 25, wherein the number of coded bits is determined as a product of:
a number of modulated symbols per layer for a given UCI;
a modulation order of the CW on which the given UCI is multiplexed; and
a number of layers mapped to the CW on which the given UCI is multiplexed.

27. The method of claim 25, wherein the number of coded bits is determined as a product of:
a number of modulated symbols per layer for a given UCI; and
a sum of
a first product of a modulation order of a first CW and a number of layers mapped to the first CW, and
a second product of a modulation order of a second CW and a number of layers mapped to the second CW.

28. A method for wireless communication by a network entity, comprising:
transmitting signaling enabling at least two code words (CWs) to be scheduled by a downlink control information (DCI);
transmitting a DCI scheduling a user equipment (UE) for a physical uplink shared channel (PUSCH) with less than two uplink transport blocks (UL TBs) with data wherein the DCI indicates at least two MCSs for the PUSCH;
determining time and frequency resources used by the UE for multiplexing uplink control information (UCI) in the PUSCH; and
processing the PUSCH with UCI multiplexed in accordance with the determination.

29-54. (canceled)

55. An apparatus, comprising at least one memory comprising instructions; and one or more processors configured to execute the instructions and cause the apparatus to:
receive signaling enabling at least two code words (CWs) to be scheduled by a downlink control information (DCI);
receive a DCI scheduling a physical uplink shared channel (PUSCH) with less than two uplink (UL) transport blocks (TBs) with data wherein the DCI indicates at least two modulation and coding schemes (MCSs) for the PUSCH;
determine time and frequency resources for multiplexing uplink control information (UCI) in the PUSCH; and
transmit the PUSCH with UCI multiplexed in accordance with the determination.

56. An apparatus, comprising at least one memory comprising instructions; and one or more processors configured to execute the instructions and cause the apparatus to:
transmit signaling enabling at least two code words (CWs) to be scheduled by a downlink control information (DCI);
transmit a DCI scheduling a user equipment (UE) for a physical uplink shared channel (PUSCH) with less than two uplink transport blocks (UL TBs) with data wherein the DCI indicates at least two MCSs for the PUSCH;
determine time and frequency resources used by the UE for multiplexing uplink control information (UCI) in the PUSCH; and
process the PUSCH with UCI multiplexed in accordance with the determination.

57-58. (canceled)
